(19) United States
(12) Patent Application Publication
(10) Pub. No.: US 2001/0056375 A1
(43) Pub. Date: Dec. 27, 2001

(54) Apparatus and method for transmitting and/or receiving information via communication network

(76) Inventor: Takashi Kunii, Shizuoka-ken (JP)

Correspondence Address: David L. Fehrman, Morrison & Foerster LLP, 35th Floor, 555 W. 5th Street, Los Angeles, CA, 90013, US

(21) Appl. No.: 09/887,746

(22) Filed: Jun. 21, 2001

(30) Foreign Application Priority Data
Jun. 22, 2000 (JP) 2000-188021

(51) Int. Cl. G06F 17/60; G09B 15/00

(52) U.S. Cl. 705/14; 84/470 R

(57) ABSTRACT

On the basis of client information (user registration information) including musical information indicative of a type or model of performance equipment being used in a particular performance practicing terminal, a management server selects advertisement information related to the type of the performance equipment, and performs control such that the selected advertisement information is transmitted to the particular performance practicing terminal via a communication network. Because the client information includes such musical information indicative of the type of the performance equipment in the particular performance practicing terminal, the management server can select appropriate advertisement information related to the type of the performance equipment in the particular performance practicing terminal, and then transmit the selected appropriate advertisement information to the performance practicing terminal. Thus, it is possible to provide effective advertisement information to each interested user with increased efficiency.

### BACKGROUND OF THE INVENTION

The present invention relates generally to information transmission/reception systems for communicating information between a server apparatus and a client apparatus via a communication network. More particularly, the present invention relates to an improved information transmitting server apparatus, information receiving client apparatus, information transmission/reception system and method for transmitting and/or receiving information which allow information, such as advertizement information or musical performance training program, to be appropriately selected for each individual client apparatus so that only the appropriate information can be efficiently supplied to the client apparatus.

Among examples of the traditional musical performance training methods for learning how to play musical instruments or musical performance equipment are: a school-attending scheme where a user or trainee attends to a music school equipped with musical instruments or musical performance equipment (namely, natural or acoustic musical instruments, or electronic musical instruments) to be used by the trainee for practicing a musical performance and where the trainee can receive musical performance training directly from an instructor; and a correspondence-based correction scheme where a user or trainee can receive musical performance training by first recording an actual performance of a particular music piece, executed by a trainee using a musical instrument or musical performance equipment, on a storage medium such as a mini disk (MD) or cassette tape and then sending that storage medium to an instructor so that the instructor can return necessary corrections of and comments on the recorded trainee's performance, usually along with the storage medium. In place of such traditional musical performance training methods, a new form of musical performance training has become increasingly more popular in recent years, in which a user or trainee can receive musical performance training by using a wired communication network, such as the Internet, or wireless communication network; that is, via the wired or wireless communication network, the trainee transmits his or her actual performance of a particular music piece on a musical instrument or musical performance equipment, so that an instructor can return necessary corrections of and comments on the trainee's performance.

Information transmission/reception systems employed for the conventional musical training using communication networks generally include a server apparatus that comprises a server computer and the like, and a plurality of client apparatus that are connected with the server apparatus and comprise a client computer with a predetermined performance operator unit and the like. In each of such client apparatus, a user practices musical performance in accordance with predetermined training steps and transmits, as necessary, results of the performance practice to the server apparatus via the communication network. In turn, the server apparatus, on the basis of the results of the performance practice received from the user, returns musical comments and advice on performance techniques, such as fingering and performance dynamics, that can not be simply practiced by the user alone, to the client apparatus via the communication network. In this way, every interested user can get musical performance training of any desired musical instrument or performance equipment even in his or her own house, using the client apparatus installed in the house or the like.

Further, it has become possible today to for every interested person to acquire a wide variety of information, such as advertisement information on newly launched products of electronic musical instruments and other products and services, by just using his or her client apparatus to access home pages posted on the Internet by server apparatus.

In the conventional musical training schemes using communication networks, the client apparatus allows the user to receive musical performance training in accordance with predetermined training steps, by the user previously purchasing a storage medium, such as a compact disk (CD) or floppy disk (FD), having collectively recorded thereon a series of musical performance training programs and installing, in the client apparatus, the musical performance training programs recorded on the purchased storage medium. Namely, with the conventional musical training schemes, the user can not get the desired musical performance training at all unless he or she has completed, in advance, necessary payment for the musical performance training programs of all the training steps. Thus, heretofore, it was difficult for the conventional information transmission/reception systems to provide flexible application of musical performance training such that a beginner, desiring to newly start practicing a musical instrument or musical equipment, is allowed to readily receive musical performance training just by way of trial, or a user, already having some experience in playing a musical instrument or musical equipment, is allowed to start musical performance practice with a certain (intermediate or advanced) training step that appears to match a current level of his or her performance skill.

Further, the conventional information transmission/reception systems are designed to only transmit/receive (i.e., communicate) various information related to musical performance training between the server apparatus and the client apparatus on the communication network; they are not designed to communicate other information than the performance-training-related information, such as advertisement information like new product information of musical instruments or sales information of CDs having recorded thereon performance-practicing music pieces (practice music pieces). As a consequence, in a situation where a user desires such other information than the performance-training-related information, it has been common for the user to obtain the desired information by referring to an information home page supplied by a predetermined server apparatus connected to the Internet. However, because an extremely great number of items of information are posted on the Internet by numerous server apparatus, the user must personally locate the desired information from among the great number of items of information. Thus, operations for locating any desired information have been very troublesome, and, in particular, it has been very difficult for a beginner to efficiently locate desired information.

### SUMMARY OF THE INVENTION

In view of the foregoing, it is an object of the present invention to provide an apparatus and method for transmitting and/or receiving information which permit flexible application of musical performance training that can fit a level of performance skill of each individual user, for example, by sequentially presenting, to the user, user-specific musical performance training programs of any appropriate training steps in accordance with a current musical performance training status of the user.

It is another object of the present invention to provide an apparatus and method for transmitting and/or receiving information which can effectively minimize a user's trouble of obtaining desired information, for example, by presenting only user-specific advisement information appropriate to the user, and which also can efficiently deliver advertisement information to the user, for example, by presenting only effective advertisement information to the user.

In order to accomplish the above-mentioned objects, the present invention provides a server apparatus for connection with a client apparatus via a communication network to transmit advertisement information to the client apparatus, and the server apparatus of the invention comprises a processor adapted to: select, on the basis of client information including musical information indicative of a type or model of performance equipment being used in a particular client apparatus, advertisement information related to the type of the performance equipment; and perform control such that the selected advertisement information is transmitted to the particular client apparatus via the communication network.

The present invention also provides a client apparatus for connection with a server apparatus via a communication network to receive advertisement information from the server apparatus, and the client apparatus of the invention comprises a processor adapted to: perform control such that client information including musical information indicative of a type of performance equipment being used in a particular client apparatus is transmitted to the server apparatus via the communication network; receive, via the communication network, advertisement information that is transmitted by the server apparatus in response to the musical information and is related to the type of the performance equipment being used in the particular client apparatus; and reproduce the advertisement information received from the server apparatus.

The present invention also provides an information transmission/reception system for connecting a client apparatus and a server apparatus via a communication network to communicate advertisement information from the server apparatus to the client apparatus. In the information transmission/reception system, the server apparatus selects, on the basis of client information including musical information indicative of a type of performance equipment being used in a particular client apparatus, advertisement information related to the type of the performance equipment, and performs control such that the selected advertisement information is transmitted to the particular client apparatus via the communication network. The client apparatus in turn receives, via the communication network, the advertisement information transmitted by the server apparatus in accordance with the type of the performance equipment being used in the particular client apparatus, and reproduces the advertisement information received from the server apparatus.

Server apparatus according to another aspect of the present invention is designed for connection with a client apparatus via a communication network to transmit advertisement information to the client apparatus, which comprises a processor adapted to: select, on the basis of client information including musical information indicative of contents of musical performance training to be received via a particular client apparatus, advertisement information related to the contents of the musical performance training to be received; and perform control such that the selected advertisement information is transmitted to the particular client apparatus via the communication network.

Client apparatus according to another aspect of the present invention is designed for connection with a server apparatus via a communication network to receive advertisement information from the server apparatus, which comprises a processor adapted to: perform control such that client information including musical information indicative of contents of musical performance training to be received via a particular client apparatus is transmitted to the server apparatus via the communication network; receive, via the communication network, advertisement information that is transmitted by the server apparatus in response to the musical information and is related to the contents of the musical performance training; and reproduce the advertisement information received from the server apparatus.

Information transmission/reception system according to another aspect of the present invention is designed for connecting a server apparatus and a client apparatus via a communication network to communicate advertisement information from the server apparatus to the client apparatus, in which the server apparatus selects, on the basis of client information including musical information indicative of contents of musical performance training to be received via a particular client apparatus, advertisement information related to the contents of the musical performance training, and performs control such that the selected advertisement information is transmitted to the particular client apparatus via the communication network. In the Information transmission/reception system, the client apparatus receives, via the communication network, the advertisement information that is transmitted by the server apparatus in accordance with the contents of the musical performance training, and reproduces the advertisement information received from the server apparatus.

Server apparatus according to still another aspect of the present invention is designed for connection with a client apparatus via a communication network to transmit a musical performance training program to the client apparatus, which comprises: a memory storing a program for use in musical training which is composed of a plurality of musical performance training programs; and a processor coupled with the memory. The processor of the server apparatus is adapted to: select any one of the plurality of musical performance training programs stored in the memory, in response to a request made by a particular client apparatus via which a user receives musical training; perform a billing operation for billing the client apparatus for the selected musical performance training program; and perform control such that the selected musical performance training program is transmitted to the particular client apparatus via the communication network.

Client apparatus according to still another aspect of the present invention is designed for connection with a server apparatus via a communication network to receive a musical performance training program from the server apparatus, the client apparatus comprising a processor adapted to: perform control such that request information requesting any one of a plurality of musical performance training programs composing a program for use in musical training is transmitted to the server apparatus via the communication network; and receive, via the communication network, one of the musical performance training programs that is transmitted by the server apparatus in response to the request information.

Program transmission/reception system according to still another aspect of the present invention is designed for connecting a server apparatus and a client apparatus via a communication network to communicate advertisement information from the server apparatus to the client apparatus, in which the server apparatus comprises: a memory storing a program for use in musical training which is composed of a plurality of musical performance training programs; and a processor coupled with the memory. The processor of the server apparatus is adapted to: select any one of the plurality of musical performance training programs stored in the memory, in response to a request made by a particular client apparatus via which a user receives musical training; perform a billing operation for billing the client apparatus for the selected musical performance training program; and perform control such that the selected musical performance training program is transmitted to the particular client apparatus via the communication network. In the program transmission/reception system, the client apparatus comprises a processor adapted to: perform control such that request information requesting any one of the plurality of musical performance training programs composing the program for use in musical training is transmitted to the server apparatus via the communication network; and receive, via the communication network, one of the musical performance training programs that is transmitted by the server apparatus in response to the request information.

The present invention may be constructed and implemented not only as the apparatus invention as discussed above but also as a method invention. Also, the present invention may be arranged and implemented as a software program for execution by a processor such as a computer or DSP, as well as a storage medium storing such a program. Further, the processor used in the present invention may comprise a dedicated processor with dedicated logic built in hardware, not to mention a computer or other general-purpose type processor capable of running a desired software program.

While the embodiments to be described herein represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its embodiments will be described in greater detail hereinbelow with reference to the accompanying drawings, in which:

FIG. 1 is a block diagram illustrating a general hardware setup of an information transmission/reception system according to an embodiment of the present invention;

FIG. 2 is a hardware block diagram showing an example of a hardware setup of one of performance practicing terminals or management server in the information transmission/reception system of FIG. 1;

FIG. 3 is a conceptual block diagram showing an exemplary operational sequence of a musical performance training process that is carried out in a musical performance training system constructed using the information transmission/reception system of FIG. 1;

FIG. 4 is a block diagram showing an example of a musical training system screen displayed on a display device in the musical performance training system of FIG. 3;

FIG. 5 is a conceptual diagram showing an exemplary setup of a program storage section in the musical performance training system;

FIG. 6 is a conceptual diagram showing an exemplary setup of a general information storage section in the musical performance training system;

FIG. 7 is a conceptual diagram showing an example of a general information screen displayed in the musical performance training system;

FIG. 8 is a conceptual diagram showing an exemplary general organization of registration information in the musical performance training system;

FIG. 9 is a conceptual diagram showing an exemplary general organization of program information in the musical performance training system;

FIG. 10 is a conceptual diagram showing an exemplary general organization of training information in the musical performance training system; and

FIG. 11 is a conceptual diagram showing an exemplary general organization of advertisement information in the musical performance training system.

### DETAILED DESCRIPTION OF EMBODIMENTS

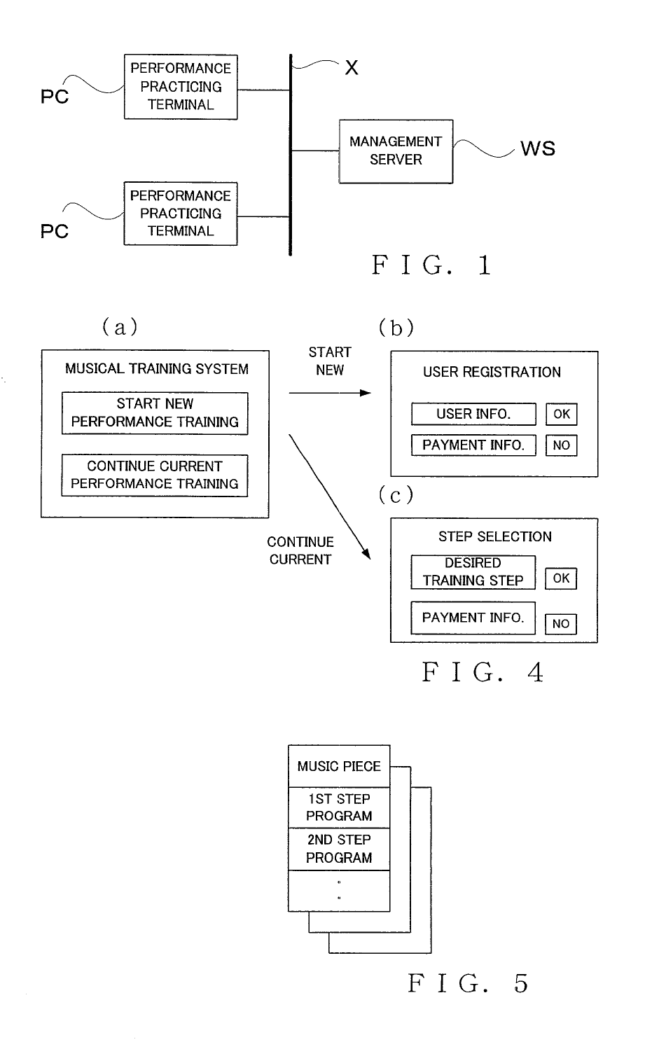

FIG. 1 is a block diagram illustrating a general hardware setup of an information transmission/reception system according to an embodiment of the present invention. This information transmission/reception system includes a plurality of performance practicing terminals PC each functioning as a client apparatus, a management server WS functioning as a server apparatus, and a communication network C connecting the practicing terminals PC and the management server WS. Each of the practicing terminals PC and management server WS, which together constitute the information transmission/reception system of the invention, is in the form of an independent computer that includes a CPU, a ROM, a RAM, a communication interface, etc., details of which will be described later. Thus, each of these apparatus in the information transmission/reception system can transmit or receive various information, such as payment information, registration information, program information and advertisement information, via the communication network X and/or dedicated communication line or through wireless communication.

Note that the information transmission/reception system of the present invention may of course include other hardware components than the above-mentioned, but a description will be made hereinbelow in relation to a case where only minimum necessary resources are employed.

Also note that a system for carrying out musical training using the inventive information transmission/reception system will hereinafter be simply called a “musical performance training system”. Namely, the following portions of this specification will describe the inventive information transmission/reception system used as the “musical performance training system”.

In the instant embodiment, the management server WS is in the form of a server computer, which functions as a server apparatus by installation therein of a predetermined controlling software program for controlling musical performance training carried out in the practicing terminals PC. Each of the performance practicing terminals PC, on the other hand, is a personal computer which functions as a client apparatus by installation therein of a predetermined musical performance training software program (musical performance training program). The management server WS and each of the practicing terminals PC are connected with each other via the communication network X, such as a LAN (Local Area Network), the Internet and/or telephone line network, so that a user of each of the performance practicing terminals PC can transmit and receive various information to and from management server WS by connecting the performance practicing terminal PC to the management server WS to access the server WS. Namely, bidirectional communication can be carried out between each of the practicing terminals PC and the management server WS. Further, each of the performance practicing terminals PC can display, on its display device, various information delivered from the management server WS, allows the user to practice a musical performance on the basis of a musical performance training program delivered from the management server WS, or executes various processes such as an automatic performance process. This way, musical training can be provided through the use of the information transmission/reception system. The terms “client information” as used herein refers to various information transmitted from any one of the performance practicing terminal PC to the management server WS.

It should be appreciated that whereas the embodiment is illustrated here in relation to the case where two performance practicing terminals PC and one management server WS are connected to the communication network X, any other number of the performance practicing terminals PC and management servers WS may be connected to the communication network X.

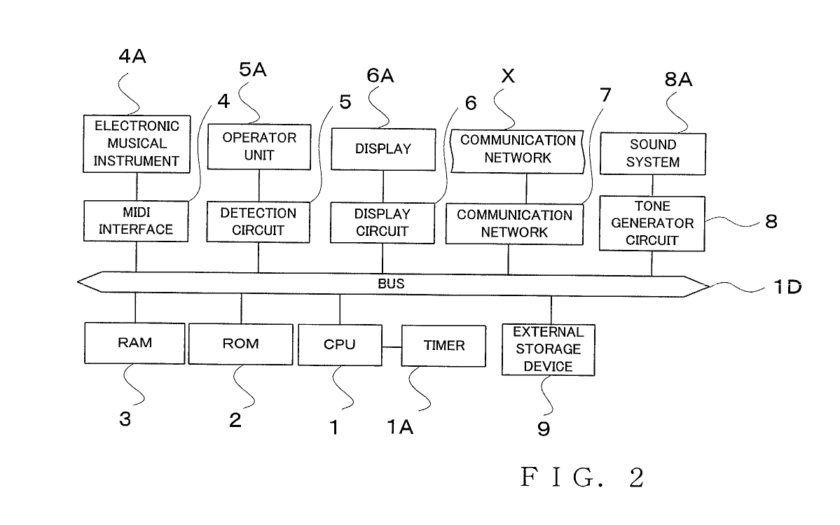

As noted above, each of the performance practicing terminals PC and management server WS comprises a similarly-constructed computer that includes a CPU, a ROM, a RAM, a communication interface, etc. Thus, the following paragraphs primarily describe the exemplary hardware setup of just one of the practicing terminals PC and management server WS, with reference to FIG. 2. Namely, FIG. 2 is a hardware block diagram showing an example of the hardware setup of one of the practicing terminals PC and management server WS in the information transmission/reception system.

Each of the practicing terminals PC (or management server WS) in the instant embodiment is controlled by a microcomputer that comprises a microprocessor unit (CPU) 1, a read-only memory (ROM) 2 and a random-access memory (RAM) 3. The CPU 1 controls operation of the entire apparatus (performance practicing terminal PC or management server WS). To the CPU 1 are connected, via a data and address bus 1D, the read-only memory (ROM) 2, random-access memory (RAM) 3, MIDI interface 4, operation detection circuit 5, display circuit 6, communication interface 7, tone generator (T.G.) circuit 8, and external storage device 9. Also connected to the CPU 1 is a timer 1A for counting various time periods, for example, to signal interrupt timing for a timer interrupt process and various other operations. Namely, the timer 1A generates tempo clock pulses for counting a time interval or setting a performance tempo. The frequency of the tempo clock pulses generated by the timer 1A is; adjustable via an panel operator unit 5A including various switches, operators, etc. Such tempo clock pulses generated by the timer 1A are given to the CPU 1 as processing timing instructions or as interrupt instructions. The CPU 1 carries out various processes in accordance with such instructions. The various processes carried out by the CPU 1 in the instant embodiment include a screen display process for visually showing, on a display device 6A, contents of musical performance training, automatic performance process for automatically performing a practice music piece for use in the musical performance training, etc., as will be later described in detail.

The ROM 2 has prestored therein various programs to be executed by the CPU 1 and various data to be referred to by the CPU 1. The RAM 3 is used as a working memory for temporarily storing various information pertaining to musical performance training (such as training information and program information), user's personal information (such as payment information and registration information) and other information (such as advertisement information), as well as tone performance conditions for use in an automatic performance of a music piece and various data generated as the CPU 1 executes the program. The RAM 3 is used also as a memory for storing a currently-executed program and data related thereto. Predetermined address regions of the RAM 3 are allocated and used as the memories, registers, flags, tables, etc.

The MIDI interface (I/F) 4 is provided for receiving or delivering MIDI tone information (MIDI data) from or to another electronic musical instrument 4A or other MIDI equipment 10A or the like outside the apparatus (i.e., performance training terminal PC or management server WS) in question. The other MIDI equipment connected to the MIDI interface 4 may be of any type having an appropriate performance operator or style, such as a keyboard type, guitar type, wind instrument type, percussion instrument type or gesture type, as long as it can generate MIDI data in response to manipulations by a user or player. Thus, the user is allowed to practice playing various electronic musical instruments 4A of different types or operating styles, by connecting any desired type or style of electronic musical instruments 4A to the MIDI interface 4. Further, a plurality of the electronic musical instruments 4A may be connected to one performance practicing terminal PC so that a plurality of users can simultaneously receive musical performance training by use of the same performance practicing terminal PC. Various types of electronic musical instruments 4A, which can be employed in the instant embodiment, each have information indicative of the particular type or model of the instrument.

Note that the MIDI interface 4 may be a general-purpose interface rather than a dedicated MIDI interface, such as RS232-C, USB (Universal Serial Bus) or IEEE1394, in which case other data than MIDI event data may be communicated at the same time; in this case, other data than MIDI event data may be communicated simultaneously with the MIDI event data. In the case where such a general-purpose interface as noted above is used as the MIDI interface 4, the external MIDI equipment, such as the other electronic musical instrument 4A, may be designed to transmit/receive other data than MIDI event data. Of course, the musical information handled in the present invention may be of any other data format than the MIDI format, in which case the MIDI interface 4 and external MIDI equipment such as the other electronic musical instrument 4A are constructed in conformity to the data format.

The panel operator unit 5A includes a ten-button keypad for entry of numeric value data and a keyboard and mouse for entry of text data, and the like. Further or alternatively, the panel operator unit 5A may also be an electronic musical instrument or performance module including a performance operator (such as a keyboard-type performance operator) which the user wants to practice playing. The operation detection circuit 5 constantly detects respective operational states of the individual operators on the panel operator unit 5A and outputs switch information and data, corresponding to the detected operational states of the operators, to the CPU 1 via the data and address bus 1D. The display circuit 6 visually shows various screens, as shown in FIGS. 4 and 7, on the display device 6A that may comprise an LCD (Liquid Crystal Display) or CRT (Cathode Ray Tube). In addition, the display circuit 6 displays, on the display device 6A, various other information, such as payment information, registration information, program information, advertisement information, program information and training information), as well as information related to a currently-performed practice music piece and controlling state of the CPU 1.

The communication interface 7 is connected to the communication network X, such as a LAN (Local Area Network), the Internet and/or telephone line network, via which it is connected to another computer such as the management server WS so that the communication interface 7 can pass various information, such as program information or advertisement information, from the management server WS to the performance practicing terminal PC. Via the communication interface 7, payment information, registration information, etc. can be transmitted from the performance practicing terminal PC to the management server WS. For instance, in a situation where a particular musical performance training program, practice music piece to be reproduced for musical performance training or the like is not stored in the ROM 2 or external storage device (e.g., hard disk device) 9 of the performance practicing terminal PC, the communication interface 7 is used to download the particular musical performance training program, practice music piece or the like from the management server WS. More specifically, the performance practicing terminal PC sends a command to request the management server WS to request downloading of the musical performance training program and various related information by way of the communication interface 7 and communication network X. In response to such a command from the performance practicing terminal PC, the management server WS delivers the requested musical performance training program and various related information to the performance practicing terminal PC via the communication network X. The performance practicing terminal PC receives the musical performance training program and various related information via the communication interface 7 and accumulatively store them into the external storage device (hard disk) 9. In this way, the necessary downloading of the musical performance training program and various related information is completed. Note that the communication interface 7 and communication network X may be capable of either or both of wired and wireless communication.

The tone generator (T.G.) circuit 8, which is capable of simultaneously generating tone signals in a plurality of channels, receives information, such as performance data related to a practice music piece via the data and address bus 1D and generates tone signals based on the received information. Each of the tone signals thus generated by the tone generator circuit 8 is audibly reproduced or sounded by a sound system 8A. The tone generator circuit 8 and sound system 8A may be constructed in any conventional manner.

The external storage device 9 is provided for storing various information, such as payment information, registration information, program information, advertisement information and training information, and data related to control of various programs executed by the CPU 1. Where a particular musical performance training program is not prestored in the ROM 2, the particular musical performance training program may be prestored in the external storage device (e.g., hard disk) 9, so that, by reading the training program from the external storage device 9 into the RAM 3, the CPU 1 is allowed to operate in exactly the same way as in the case where the particular musical performance training program is stored in the ROM 2. This arrangement greatly facilitates version upgrade of the program, addition of a new musical performance training program, etc. The external storage device 9 may use any of various removable-type media other than the hard disk (HD), such as a floppy disk (FD), compact disk (CD), magneto-optical disk (MO), digital versatile disk (DVD) and other removable-type storage media.

Note that the management server WA may dispense with the electronic musical instrument 4A for practicing a musical performance, tone generator circuit 8 and sound system 8A for tone generation. Further, each of the performance practicing terminals PC and management server WS may be in the form of any desired apparatus as long as it can transmit/receive various information and carry out musical performance training by use of predetermined software programs or hardware configured in accordance with the present invention. For example, each of the performance practicing terminals PC may be in the form of a portable communication terminal capable of wireless communication, such as a cellular phone or personal data (digital) assistant (PDA). In the case where such a portable communication terminal is used as the performance practicing terminal PC, the user can practice a music performance in any place, indoor or outdoor, other than his or her house where the performance practicing terminal PC, such as a personal computer, is installed.

In the musical performance training system using the information transmission/reception system shown in FIG. 1, each individual performance practicing section (consisting, for example, of several measures) of a practice music piece is divided into a plurality of performance training steps. Musical performance training programs for implementing the individual performance training steps are supplied sequentially (one by one) from the management server WS to the requesting performance practicing terminal PC, so that the user of the practicing terminal PC can progressively go ahead with the musical performance practice or training of the practice music piece. For example, the performance training steps may include: a first training step where the user is requested to practice with primary emphasis on operating the performance operator at the same pitches as dictated by the practice music piece and without necessarily having to faithfully operate the performance operator at the same timing as dictated by the practice music piece; a second training step where the user is requested to operate the performance operator at the same timing as dictated by the practice music piece without necessarily having to faithfully operate the performance operator at the same pitches as dictated by the practice music piece; a third training step where the user is requested to operate the performance operator both at the same pitches and at the same timing as dictated by the practice music piece; and a fourth training step where the user is requested to operate the performance operator to perform complicated phrases containing chords and the like that requires advanced performance skill. When such musical performance training programs corresponding to the performance training steps are supplied from the management server WS to the requesting performance practicing terminal PC, a billing process is performed by the server apparatus WS to charge the user of the practicing terminal PC for a preset fee to be paid for each of the musical performance training programs. In addition to the musical performance training programs, the management server WS may supply each individual user with information (e.g., advertisement information) carefully selected according to a current training step or status of the user.

In the above-mentioned manner, the musical performance training system of the present invention can eliminate the prior art inconveniences that the user can not at all initiate the musical performance practice or training unless he or she has completed necessary payment for the musical performance training programs of all the training steps, and thus it can greatly promote motivation or eagerness of users or potential trainees for the musical performance training because the preset fee is charged only for the musical performance training program of a particular training step which the user wants to receive.

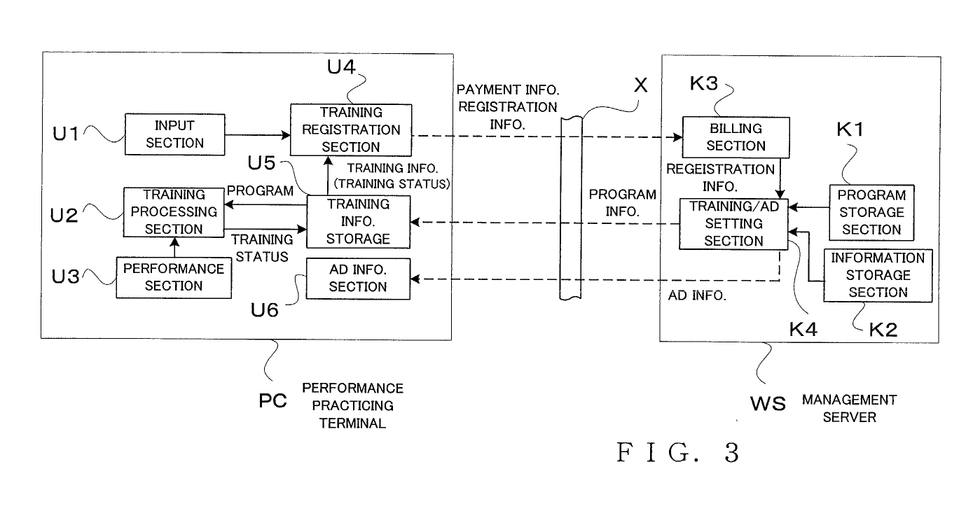

Now, with reference to FIG. 3, a detailed description will be made about an operational sequence of a musical performance training process that is carried out in the musical performance training system constructed using the information transmission/reception system shown in FIG. 1. FIG. 3 is a conceptual block diagram showing the operational sequence of the musical performance training process in the musical performance training system. For purposes of simplification, the following paragraph describes an exemplary operational sequence of the musical performance training process carried out between one management server WS and one performance practicing terminal PC connected to the communication network X.

Training registration section U4 connects the performance practicing terminal PC to the management server WS via the communication network X, and thereby visually displays, on the display device 6A of the performance practicing terminal PC, a musical training system screen (see part (a) of FIG. 4 that will be described later) to prompt the user to make registration necessary for starting new performance training or continuing current performance training. If the user selects “start new performance training”, the training registration section U4 generates and displays a new registration screen (see part (b) of FIG. 4) to prompt the user to enter necessary information. If the user selects “continue current performance training”, the training registration section U4 generates and displays a current training continuation screen (see part (c) of FIG. 4) to prompt the user to enter necessary information. Once the user enters or inputs the necessary information on the basis of the displayed registration or continuation screen via an input section U1, the training registration section U4 generates payment information and registration information on the basis of the user-entered information, and then transmits, via the communication network X, the payment information and registration information to a billing section K3 of the management server WS. Here, the “payment information” represents a user-desired method of payment and various items of information necessary for the user-desired method of payment. The method of payment is a way of paying a fee of the registered musical performance training, such as payment by a credit card, bank account transfer, postal transfer, electronic money or the like. The information necessary for the user-desired method of payment includes a credit card number and the like in the case of the payment by a credit card, account number, account holder's name and the like in the case of the payment by a bank account or postal account transfer, or user's personal information and the like in the case of the payment by electronic money. Further, the registration information includes information generated on the basis of contents of registration-related information entered by the user via the musical training system screen and current training status of the user stored in the performance practicing terminal PC, as will be later described in detail.

Part (a) of FIG. 4 shows an example of the musical training system screen displayed on the display device 6A. This musical training system screen is displayed on the display device 6A of the performance practicing terminal PC when the practicing terminal PC accesses the management server WS via the communication network X using a network browser. On the musical training system screen, an operation area is first shown to allow the user to make a selection as to whether new performance training should be started (“start new performance training”) or current performance training should be continued (“continue current performance training”). When the “start new performance training” option in the operation area has been selected using the mouse or the like, the musical training system start screen shifts to a user registration screen as shown in part (b) of FIG. 4. The user is allowed to newly start musical performance training by executing user registration using this user registration screen. On the user registration screen, there are shown a user information input area and a payment information input area. For registration of user information, the user enters, via the user information input area, the name, age, address and e-mail address of the user, music piece which the user wants to practice performing, model name of the electronic musical instrument used by the user, performance experience or history of the user, etc. Via the payment information input area, the user enters a desired method of payment and other payment-related information necessary for the registration.

When, on the other hand, the “continue current performance training” option has been selected by the user on the musical training system start screen, the screen shifts to a training step selection screen (part (c) of FIG. 4). The training step selection screen is a screen for the user to go ahead with the musical performance practice by paying for each training step which the user wants to take. On the training step selection screen, there are shown a desired training step input area and a payment information input area. Via the desired training step input area, the user selectively enters a training step or new music piece which he or she wants to practice performing. Via the payment information input area, the user enters a desired method of payment and other payment-related information necessary for performance practice of the entered desired training step or new music piece. As noted earlier, performance practice of each music piece is accomplished through a plurality of training steps. The training steps are presented to the user in predetermined order in accordance with musical performance training programs and training information indicative of a user's current training status that are stored in the performance practicing terminal PC. Upon completion of one specific training step, the user is prompted to proceed to (i.e., sign up for) the next training step. Detailed contents of the performance training in the individual training steps are chosen such that the performance level or skill of the user can rise stepwise from a very simple elementary level to an advanced level; for example, the simple elementary training may be focused on performance position practice where the user or trainee is instructed to practice playing accurate performance positions of the performance operator unit (e.g., keys to be depressed on a keyboard) while paying less attention to the performance timing, the next training may be focused on performance timing where the user or trainee is instructed to practice playing at accurate performance timing while paying less attention to the performance positions of the performance operator unit.

Referring back to FIG. 3, the training registration section U4 of the performance practicing terminal PC generates the payment information and registration information on the basis of the information entered by the user via the above-described screens, and then transmits, via the communication network X, the payment information and registration information to the billing section K3 of the management server WS. On the basis of the payment information and registration information received from the practicing terminal PC, the billing section K3 bills the practicing terminal PC for the musical performance training (new performance training or new training step) desired by the user; note that the payment for the bill may be made by a credit card, bank account transfer, postal transfer, electronic money or any other suitable means, as noted above. Upon completion of the billing operation, the billing section K3 passes the received registration information to a training/advertisement setting section K4, so as to generate program information corresponding to the user-desired training step and transmit the thus-generated program information to the performance practicing terminal PC.

Namely, upon receipt of the registration information passed from the billing section K3, the training/advertisement setting section K4 generates the program information by reading out, from a program storage section K1 of the server WS, a musical performance training program corresponding to the user-desired training step (i.e. a musical performance training program for a first training step in the case where the “start new performance training” option has been selected by the user, or a musical performance training program for a selected training step in the case where the “continue current performance training” option has been selected by the user. In addition, the training/advertisement setting section K4 generates advertisement information by reading out, from a general information storage section K2 of the server, related information with reference to the user information and user's training status. The thus-generated program information and advertisement information is transmitted to the performance practicing terminal PC.

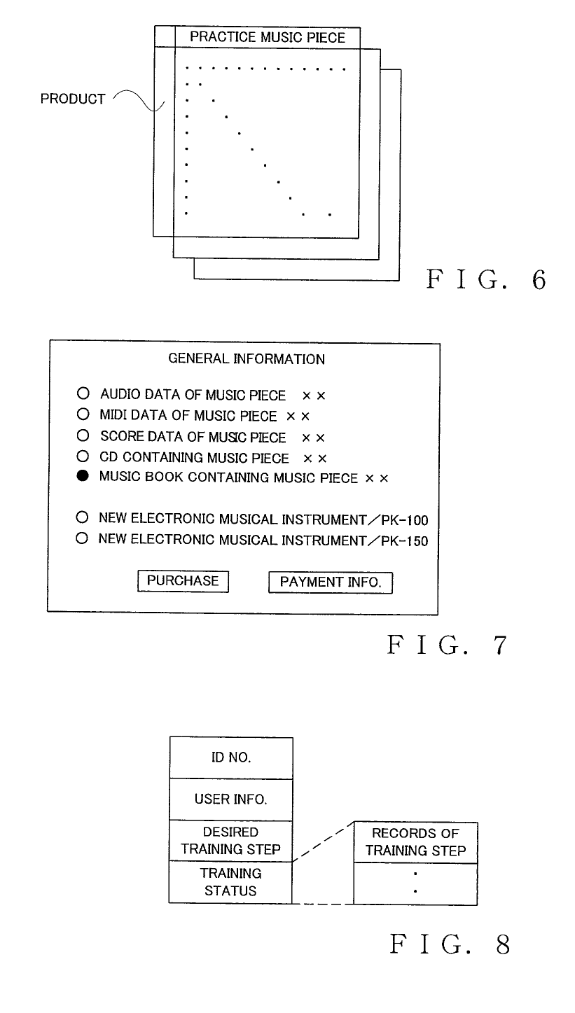

FIG. 5 is a conceptual diagram showing an exemplary setup of the program storage section K1 and general information storage section K2, and FIG. 6 is a conceptual diagram showing an exemplary setup of the general information storage section K2.

As seen from FIG. 5, the program storage section K1 stores therein musical performance training programs of a plurality of music pieces. The overall training program of each music piece comprises a plurality of musical performance training programs, such as a first musical performance training program, second musical performance training step program and so on, which are stored sequentially on a step-by-step basis. Namely, the musical performance training programs are stored sequentially in a stepwise fashion, in order to allow the user to get musical performance training only for a selected training step or level of difficulty of the performance training. The overall training program also contains musical piece (practice music piece) information for use in the performance training.

The general information storage section K2 stores therein various items of general information (such as advertisement information) to be presented or supplied to the user. As seen from FIG. 6, the various items of general information are stored in the general information storage section K2 in such a manner that a particular one of the items can be selected, for example, in a matrix-like fashion by use of a combination of two pieces of index information; that is, the general information storage section K2 is a database through which one particular items of information can be searched for on the basis of two pieces of index information. In FIG. 6, there is shown a case where appropriate advertisement information is selectively read out on the basis of a combination of practice music piece information currently used by the user for musical performance practice and information of a product currently sold by a given maker. The index information may be of any desired type; for example, there may be used a combination of the user's age and sex, a combination of the user&s age and type or model of the electronic musical instrument possessed by the user, or the like. The advertisement information read out in this manner may be appropriate sales information of electronic musical instruments corresponding to the combination of the index information. It should also be appreciated that appropriate advertisement information may be sent to the user on the basis of a hierarchical combination of three or more pieces of index information, rather than a combination of just two pieces of index information.

Referring back to FIG. 3, a training information storage section U5 of the performance practicing terminal PC receives information indicative of a user's training status output from a training processing section U2, and the program information sent from the training/advertisement setting section K4 of the management server WS via the communication network X. The training information storage section U5 stores contents of training information while updating the contents on the basis of the received information. Also, the training information storage section U5 passes the musical performance training program, contained in the training information, to the training processing section U2. More specifically, upon receipt of the program information from the training/advertisement setting section K4, updates the contents of the training information to reflect (add thereto) the contents of the received program information, and thereby creates information indicative of a new training program status. Once a training process is initiated in the performance practicing terminal PC, the training information storage section U5 passes the musical performance training program, contained in the training information, to the training processing section U2, so that the user can do musical performance practice corresponding to the training program. Namely, the training processing section U2, on the basis of the musical performance training program passed from the training information storage section U5, carries out the training process while displaying a musical score of the practice music piece and automatically reproducing tones of the practice music piece. The user practices musical performance using a performance section U3 such as a keyboard-based electronic musical instrument. Of course, the user is allowed to interrupt the musical performance practice halfway and resume the performance practice at the interrupted position thereof. Then, information indicative of a user's training status is transmitted from the training processing section U2 to the training information storage section U5 as appropriate. Upon receipt of the training status information from the training processing section U2, the training information storage section U5 updates the contents of the training information to reflect (add thereto) the contents of the received training status information.

Further, an advertisement information section U6 of the performance practicing terminal PC shows, on the display device 6A, various information (see a “general information screen” of FIG. 7 that will also be described later) on the basis of the advertisement information received from the management server WS. On the basis of the displayed general information including product information, the user can purchase a desired product. In this case, the purchase of the desired product is permitted through the operation of the billing section K3 in the management server WS. Note that the purchased product may be delivered in any suitable manner; for example, the purchased product may be sent via the communication network X to the performance practicing terminal PC if the product delivery is to be executed after necessary payment for the product (as in the case of payment by a credit card or electronic money), or a storage medium having the purchased product recorded thereon may be sent to a designated address of the user if the product delivery is to be executed prior to the necessary payment for the product (as in the case of payment by a bank account transfer or postal transfer).

FIG. 7 is a conceptual diagram showing an example of the above-mentioned general information screen including the product information. The general information screen of FIG. 7 is a screen for visually showing information related to the musical performance training which the user is now attending to, user's personal information and other information on the basis of the advertisement information received from the training/advertisement setting section K4 of the management server WS and using the network browser. The information related to the musical performance training displayed on the general information screen include such items that inform the user of audio data, MIDI data and musical score of the music piece the user is now practicing and sales statuses of CDs having the music piece recorded thereon, with a view to prompting the user to purchase any of the products. The user's personal information displayed on the general information screen include such an item that informs the user of a new model product corresponding or similar to the electronic musical instrument currently used by the user, and other information corresponding to the age and sex of the user such as advertisement for music schools to practice playing musical instruments, current popular musical instruments and current popular music pieces, with a view to prompting the user to purchase any of the products or join any of the music schools. Further, the other information displayed on the general information screen includes seasonable information such as advertisement for music pieces and musical instruments suiting the New Year, Christmas time and summer time, and information related to recent musical news. The user is allowed to purchase any of the data, musical score, CD, electronic musical instruments, etc. on the general information screen, by selecting the corresponding button of the displayed information and performing “purchase” and “payment information input” operations. In the instant embodiment, the user can select the desired item of the displayed information by clicking a corresponding one of radio buttons “∘” on the general information screen.

Now, a further description will be made about the registration information, program information, training information and advertisement information in the musical performance training process shown in FIG. 3.

FIG. 8 is a conceptual diagram showing an exemplary general organization of the registration information. The registration information includes various items of user-related information, such as one representing an environment in which the user is practicing musical performance (e.g., the model number of the electronic musical instrument currently used by the user), user's personal information and user's training status. When the “start new performance training” option has been selected by the user (see the “musical training system screen” shown in part (a) of FIG. 4), the registration information includes, in addition to the above-mentioned items, user-specific identification information given by the management server WS and user information entered by the user; in this case, the first training step is automatically selected as a user-desired training step, and no data indicative of the user's training status is included in the registration information. When the “continue current performance training” option has been selected by the user on the musical training system screen, on the other hand, the registration information includes, in addition to the above-mentioned items, user-specific identification information given by the management server WS, updated user information containing any changes from the last user information, desired training step information indicative of a training step (or new music piece) entered as a user-desired training step, information indicative of a training status stored in the training information storage section U5 of the practicing terminal PC. The information indicative of the training status comprises various items of information representing a user's training status, progress of the training and, typically, includes step progress information. The step progress information represents which one of the training steps is now being taken or has just been completed by the user and chronological records of progress in individual training steps so far completed by the user. Contents of a desired training step, selectable by the user on the “continue current performance training” during the registration, can be controlled on the basis of such step progress information; for example, on the basis of the step progress information, control can be performed such that the user is allowed to select only a training step or steps following the training step completed just now or that there are displayed only a training step or steps selectable in accordance with the step progress. The registration information also includes various other items of information that represent records of every music piece so far practiced, records of each music piece for which all the training steps have been completed, the number of times musical performance training has been executed, the time of each performance training executed, contents of the performance training (such as the number of errors made in the performance training, position of each error made in the performance training, performance training schedule), etc.

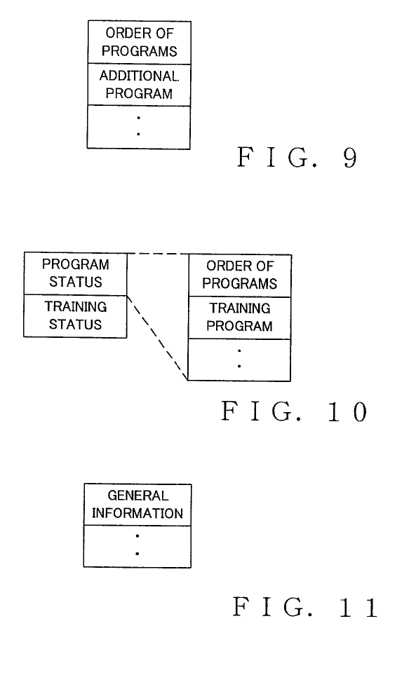

Further, FIG. 9 is a conceptual diagram showing an exemplary general organization of the program information. The program information includes a musical performance training program for allowing the user to get performance training corresponding to the registration information entered by the user (i.e., user-desired performance training). To store the program information, a musical performance training program corresponding to a user-desired training step and practice music piece is read out from the program storage section K1 with reference to the user-desired training step and practice music piece, and the thus read-out training program is stored into the program information in order of performance training to be executed.

Further, FIG. 10 is a conceptual diagram showing an exemplary general organization of the training information. The training information comprises items of information representing program status and training status. The program status information includes various items of information necessary for musical performance training. The various items of information necessary for musical performance training include one representative of musical performance training programs for individual training steps and a music piece (practice music piece) to be used for the performance training. The musical performance training programs for individual training steps, contained in the program information sent from the management server WS, are stored in the training information in order of performance training to be executed. Each time the program information is received, a musical performance training program for a new training step is additionally stored into the training information. In the training status information, there is stored a user's training status passed from the training processing section U2.

Furthermore, FIG. 11 is a conceptual diagram showing an exemplary general organization of the advertisement information. This advertisement information includes general information corresponding to the registration information entered by the user (i.e., general information most suitable for the user). General information corresponding to the user information and training status contained in the registration information is read out from the general information storage section K2 with reference to the user information and training status, and the thus read-out general information is sequentially stored into the advertisement information.

The programs used in the musical training system of the present invention include a basic program in addition to the above-described programs for the individual training steps. The basic program may be transmitted, via the communication network X, along with the programs for the individual training steps when musical performance training is newly initiated, or may be prestored in an electronic musical instrument to be purchased by a user. Further, arrangements may be made such that the user can have the musical performance training programs for a first few training steps downloaded, free of charge, from a predetermined information home page via the communication network X. Alternatively, arrangements may be made such that a storage medium, such as a CD or FD, having recorded thereon the musical performance training programs for a first few training steps may be supplied to the user, free of charge, by being affixed to an electronic musical instrument purchased by the user. In this way, trial use of the musical performance training programs is permitted where the user gets only a selected portion of the performance training just on a trial basis. Such trial use may lead to a good chance of acquiring a greater number of users or trainees of the musical performance training.

Furthermore, the training information related to user's musical performance practice may be prestored in the management server WS, in which case various information to be supplied to the performance practicing terminal PC can be set properly by the practicing terminal PC transmitting only an updated portion of performance information to the management server WS.

Note that the information indicative of the type or model of performance equipment (such as an electronic musical instrument or portable communication terminal) being used by the user may be automatically affixed to other information (such as the registration information or payment information) transmitted from the user so that the type or model can be identified from the automatically affixed information.

It should also be appreciated that in the case where an electronic musical instrument is used as a performance operator unit for musical performance practice, the electronic musical instrument may be of any other type than the keyboard type, such as a stringed instrument, wind instrument or percussion instrument type. It should also be noted that the electronic musical instrument is not limited to the type where the tone generator device, automatic performance device, etc. are incorporated together within the body of the electronic musical instrument, and may be of another type where the tone generator device, automatic performance device, etc. are provided separately from each other but can be connected with each other via MIDI interfaces and communication facilities such as a communication network. Further, the electronic musical instrument may comprise a combination of a personal computer and application software, in which case various processing programs may be supplied from a storage medium, such as a magnetic disk, optical disk or semiconductor memory or via a communication network. Further, the present invention may be applied to an automatic performance apparatus such as a karaoke apparatus or player piano.

It should also be appreciated that in the case where the present invention is applied to an automatic performance apparatus, the performance data of a practice music piece for use in the musical performance training may be in any desired format, such as: the “event plus absolute time” format where the time of occurrence of each performance event is represented by an absolute time within the music piece or a measure thereof; the “event plus relative time” format where the time of occurrence of each performance event is represented by a time length from the immediately preceding event; the “pitch (rest) plus note length” format where each performance data is represented by a pitch and length of a note or a rest and a length of the rest; or the “solid” format where a memory region is reserved for each minimum resolution of a performance and each performance event is stored in one of the memory regions that corresponds to the time of occurrence of the performance event. Furthermore, where performance data sets for a plurality of channels are handled in the present invention, the performance data for the plurality of channels may be stored together in a mixture or the performance data sets for the channels may be separated from each other on a track-by-track basis.

According to one of the above-described embodiments of the present invention, the server apparatus, on the basis of the client information, transmits, to the client apparatus, advertisement information related to the type or model of the performance equipment being used in the client apparatus. The performance equipment is one which can be manipulated by the user to execute a musical performance, and the client information includes musical information that is indicative of the type of the performance equipment being used in the client apparatus. On the basis of the client information including such musical information, the server apparatus selects advertisement information and transmits the selected advertisement information to the client apparatus. Namely, the server apparatus is arranged to select the advertisement information to be delivered to the client apparatus, on the basis of the client information including the musical information indicative of the type of the performance equipment being used in the client apparatus. Thus, for each interested user, it is possible to transmit appropriate advertisement information; that is, the embodiment can provide effective advertisement information to each interested user with increased efficiency.

According to another one of the above-described embodiments of the present invention, the client apparatus is arranged to transmit client information, including musical information indicative of the type of performance equipment being used in the particular client apparatus, to the server apparatus via the communication network. Then, the client apparatus receives, via the communication network, advertisement information related to the type of performance equipment that is delivered from the server apparatus, and then reproduces the received advertisement information. With such arrangements, the embodiment can effectively minimize a user's trouble of obtaining desired advertisement information.

Further, the information transmission/reception system in accordance with still another one of the above-described embodiments of the present invention can effectively minimize a user's trouble of obtaining desired advertisement information and also can provide only effective advertisement information to each interested user with increased efficiency.

In summary, the present invention allows a user to flexibly execute performance practice in accordance with a level of user's performance skill, by presenting the user with a musical performance training program of any suitable or desired training step in accordance with a user-specific performance training status.

Further, the present invention presents each user with only such advertisement information that is pertinent or appropriate to the user. With this arrangement, it can effectively minimize a user's trouble of obtaining desired advertisement information and provide only effective advertisement information to each interested user. Thus, the present invention can advantageously deliver the advertisement information with increased efficiency.

What is claimed is:

1. A server apparatus for connection with a client apparatus via a communication network to transmit advertisement information to said client apparatus, said server apparatus comprising a processor adapted to:
select, on the basis of client information including musical information indicative of a type of performance equipment being used in a particular client apparatus, advertisement information related to the type of the performance equipment; and
perform control such that the selected advertisement information is transmitted to said particular client apparatus via the communication network.

2. A server apparatus as claimed in claim 1 wherein the advertisement information is advertisement information for encouraging purchase of a product related to the type of the performance equipment being used in said particular client apparatus.

3. A server apparatus as claimed in claim 1 wherein the client information includes non-musical general information in addition to the musical information, and wherein said processor selects the advertisement information on the basis of the musical information in combination with the non-musical general information.

4. A client apparatus for connection with a server apparatus via a communication network to receive advertisement information from said server apparatus, said client apparatus comprising a processor adapted to:
perform control such that client information including musical information indicative of a type of performance equipment being used in a particular client apparatus is transmitted to said server apparatus via the communication network;
receive, via the communication network, advertisement information that is transmitted by said server apparatus in response to the musical information and is related to the type of the performance equipment being used in said particular client apparatus; and
reproduce the advertisement information received from said server apparatus.

5. A client apparatus as claimed in claim 4 wherein the advertisement information is advertisement information for encouraging purchase of a product related to the type of the performance equipment being used in said particular client apparatus, and wherein said processor reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

6. An information transmission/reception system for connecting a client apparatus and a server apparatus via a communication network to communicate advertisement information from said server apparatus to said client apparatus,
wherein said server apparatus selects, on the basis of client information including musical information indicative of a type of performance equipment being used in a particular client apparatus, advertisement information related to the type of the performance equipment, and performs control such that the selected advertisement information is transmitted to said particular client apparatus via the communication network, and
wherein said client apparatus receives, via the communication network, the advertisement information transmitted by said server apparatus in accordance with the type of the performance equipment being used in said particular client apparatus, and reproduces the advertisement information received from said server apparatus.

7. An information transmission/reception system as claimed in claim 6 wherein the advertisement information is advertisement information for encouraging purchase of a product related to the type of the performance equipment being used in said particular client apparatus.

8. An information transmission/reception system as claimed in claim 6 wherein the client information includes non-musical general information in addition to the musical information, and said server apparatus selects the advertisement information on the basis of the musical information in combination with the non-musical general information.

9. An information transmission/reception system as claimed in claim 6 wherein the advertisement information is advertisement information for encouraging purchase of a product related to the type of the performance equipment being used in said particular client apparatus, and wherein said client apparatus reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

10. A server apparatus for connection with a client apparatus via a communication network to transmit advertisement information to said client apparatus, said server apparatus comprising a processor adapted to:
select, on the basis of client information including musical information indicative of contents of musical performance training to be received via a particular client apparatus, advertisement information related to the contents of the musical performance training to be received; and
perform control such that the selected advertisement information is transmitted to said particular client apparatus via the communication network.

11. A server apparatus as claimed in claim 10 wherein the advertisement information is advertisement information for encouraging purchase of a product related to the contents of the musical performance training to be received via said particular client apparatus.

12. A server apparatus as claimed in claim 10 wherein the client information includes non-musical general information in addition to the musical information, and said server apparatus selects the advertisement information on the basis of the musical information in combination with the non-musical general information.

13. A client apparatus for connection with a server apparatus via a communication network to receive advertisement information from said server apparatus, said client apparatus comprising a processor adapted to:
perform control such that client information including musical information indicative of contents of musical performance training to be received via a particular client apparatus is transmitted to said server apparatus via the communication network;
receive, via the communication network, advertisement information that is transmitted by said server apparatus in response to the musical information and is related to the contents of the musical performance training; and
reproduce the advertisement: information received from said server apparatus.

14. A client apparatus as claimed in claim 13 wherein the advertisement information is advertisement information for encouraging purchase of a product related to the contents of the musical performance training to be received via said particular client apparatus, and wherein said client apparatus reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

15. An information transmission/reception system for connecting a server apparatus and a client apparatus via a communication network to communicate advertisement information from said server apparatus to said client apparatus,
wherein said server apparatus selects, on the basis of client information including musical information indicative of contents of musical performance training to be received via a particular client apparatus, advertisement information related to the contents of the musical performance training, and performs control such that the selected advertisement information is transmitted to said particular client apparatus via the communication network, and
wherein said client apparatus receives, via the communication network, the advertisement information that is transmitted by said server apparatus in accordance with the contents of the musical performance training, and reproduces the advertisement information received from said server apparatus.

16. An information transmission/reception system as claimed in claim 15 wherein the advertisement information is advertisement information for encouraging purchase of a product related to the contents of the musical performance training to be received via said particular client apparatus.

17. An information transmission/reception system as claimed in claim 15 wherein the client information includes non-musical general information in addition to the musical information, and wherein said server apparatus selects the advertisement information on the basis of the musical information in combination with the non-musical general information.

18. An information transmission/reception system as claimed in claim 15 wherein the advertisement information is advertisement information for encouraging purchase of a product related to the contents of the musical performance training to be received via said particular client apparatus, and wherein said client apparatus reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

19. A server apparatus for connection with a client apparatus via a communication network to transmit a musical performance training program to said client apparatus, said server apparatus comprising:
a memory storing a program for use in musical training which is composed of a plurality of musical performance training programs; and
a processor coupled with said memory and adapted to:
select any one of the plurality of musical performance training programs stored in said memory, in response to a request made by a particular client apparatus via which a user receives musical training;
perform a billing operation for billing said client apparatus for the selected musical performance training program; and
perform control such that the selected musical performance training program is transmitted to said particular client apparatus via the communication network.

20. A server apparatus as claimed in claim 19 wherein said processor is further adapted to select music-related advertisement information on the basis of client information specific to said particular client apparatus via which a user receives the musical training, and adapted to perform control such that the selected advertisement information is transmitted, along with the selected musical performance training program, to said particular client apparatus via the communication network.

21. A server apparatus as claimed in claim 20 wherein the client information includes musical information indicative of a type of performance equipment being used in said particular client apparatus, and the advertisement information is advertisement information related to the type of the performance equipment.

22. A server apparatus as claimed in claim 21 wherein the advertisement information is advertisement information for encouraging purchase of a product related to the type of the performance equipment being used in said particular client apparatus.

23. A server apparatus as claimed in claim 21 wherein the client information includes non-musical general information in addition to the musical information, and wherein said processor selects the advertisement information on the basis of the musical information in combination with the non-musical general information.

24. A server apparatus as claimed in claim 20 wherein the client information includes musical information indicative of contents of musical performance training to be received via said particular client apparatus, and the advertisement information is advertisement information related to the contents of the musical performance training.

25. A server apparatus as claimed in claim 24 wherein the advertisement information is advertisement information for encouraging purchase of a product related to the contents of the musical performance training to be received via said particular client apparatus.

26. A server apparatus as claimed in claim 24 wherein the client information includes non-musical general information in addition to the musical information, and wherein said processor selects the advertisement information on the basis of the musical information in combination with the non-musical general information.

27. A server apparatus as claimed in claim 24 wherein the advertisement information is advertisement information for encouraging purchase of a product related to the contents of the musical performance training to be received via said particular client apparatus, and wherein said client apparatus reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

28. A client apparatus for connection with a server apparatus via a communication network to receive a musical performance training program from said server apparatus, said client apparatus comprising a processor adapted to:
perform control such that request information requesting any one of a plurality of musical performance training programs composing a program for use in musical training is transmitted to said server apparatus via the communication network; and
receive, via the communication network, one of the musical performance training programs that is transmitted by said server apparatus in response to the request information.

29. A client apparatus as claimed in claim 28 wherein said client apparatus performs control such that client information specific to said particular client apparatus is transmitted, along with the request information, to said server apparatus via the communication network, and wherein said client apparatus receives, via the communication network, music-related advertisement information that is transmitted, along with the musical performance training program, by said server apparatus in response to the client information, and then reproduces the advertisement information received from said server apparatus.

30. A client apparatus as claimed in claim 29 wherein the client information includes musical information indicative of a type of performance equipment being used in said client apparatus, and the advertisement information is advertisement information related to the type of the performance equipment.

31. A client apparatus as claimed in claim 29 wherein the client information includes musical information indicative of contents of musical performance training to be received via said client apparatus, and the advertisement information is advertisement information related to the contents of the musical performance training.

32. A client apparatus as claimed in claim 29 wherein the advertisement information is advertisement information for encouraging purchase of a product related to a type of performance equipment being used in said client apparatus, and wherein said client apparatus reproduces the advertisement information by displaying, on the basis of the advertisement information, a screen for encouraging the purchase of the product, and, on the basis of a predetermined purchasing operation executed using the screen, informs said server apparatus that a user of said client apparatus wants to purchase the product.

33. A program transmission/reception system for connecting a server apparatus and a client apparatus via a communication network to communicate advertisement information from said server apparatus to said client apparatus,
wherein said server apparatus comprises:
a memory storing a program for use in musical training which is composed of a plurality of musical performance training programs; and
a processor coupled with said memory and adapted to:
select any one of the plurality of musical performance training programs stored in said memory, in response to a request made by a particular client apparatus via which a user receives musical training;
perform a billing operation for billing said client apparatus for the selected musical performance training program; and
perform control such that the selected musical performance training program is transmitted to said particular client apparatus via the communication network, and
wherein said client apparatus comprises a processor adapted to:
perform control such that request information requesting any one of the plurality of musical performance training programs composing the program for use in musical training is transmitted to said server apparatus via the communication network; and
receive, via the communication network, one of the musical performance training programs that is transmitted by said server apparatus in response to the request information.

34. A program transmission/reception system as claimed in claim 33 wherein said processor of said server apparatus is further adapted to select musical-related advertisement information on the basis of client information specific to said particular client apparatus via which a user receives the musical training, and adapted to perform control such that the selected advertisement information is transmitted, along with the selected musical performance training program, to said particular client apparatus via the communication network.

35. A program transmission/reception system as claimed in claim 34 wherein the client information includes musical information indicative of a type of performance equipment being used in said particular client apparatus, and the advertisement information is advertisement information related to the type of the performance equipment.

36. A program transmission/reception system as claimed in claim 34 wherein the client information includes musical information indicative of contents of musical performance training to be received via said particular client apparatus, and the advertisement information is advertisement information related to the contents of the musical performance training.

37. A program transmission/reception system as claimed in claim 33 wherein said particular client apparatus performs control such that client information specific to said particular client apparatus is transmitted, along with the request information, to said server apparatus via the communication network, and wherein said particular client apparatus receives, via the communication network, music-related advertisement information that is transmitted, along with the musical performance training program, by said server apparatus in response to the client information, and then reproduces the advertisement information received from said server apparatus.

38. A program transmission/reception system as claimed in claim 37 wherein the client information includes musical information indicative of a type of performance equipment being used in said particular client apparatus, and the advertisement information is advertisement information related to the type of the performance equipment.

39. A program transmission/reception system as claimed in claim 37 wherein the client information includes musical information indicative of contents of musical performance training to be received via said particular client apparatus, and the advertisement information is advertisement information related to the contents of the musical performance training.

40. A program transmission/reception system as claimed in claim 37 wherein the advertisement information is advertisement information for encouraging purchase of a product related to the type of the performance equipment being used in said particular client apparatus, and wherein said particular client apparatus reproduces the advertisement information by displaying, on the basis of the advertisement information, a screen for encouraging the purchase of the product, and, on the basis of a predetermined purchasing operation executed using the screen, informs said server apparatus that a user of said particular client apparatus wants to purchase the product.

41. A method for supplying information from a server apparatus to a client apparatus via a communication network, said method comprising:
a step of selecting, on the basis of client information including musical information indicative of a type of performance equipment being used in a particular client apparatus, advertisement information related to the type of the performance equipment; and
a step of performing control such that the advertisement information selected via said step of selecting is transmitted to said particular client apparatus via the communication network.

42. A method for communicating information between a server apparatus and a client apparatus via a communication network, said method comprising:
a step of performing control such that client information including musical information indicative of a type of performance equipment being used in a particular client apparatus is transmitted to said server apparatus via the communication network; and
a step of receiving, via the communication network, advertisement information that is transmitted by said server apparatus in response to the musical information and is related to the type of the performance equipment being used in said particular client apparatus, and reproducing the advertisement information received from said server apparatus.

43. A method for communicating information between a server apparatus and a client apparatus via a communication network, said method comprising:
a step of causing said server apparatus to select, on the basis of client information including musical information indicative of a type of performance equipment being used in a particular client apparatus, advertisement information related to the type of the performance equipment;
a step of causing said server apparatus to perform control such that the advertisement information selected by said server apparatus is transmitted to said particular client apparatus via the communication network; and
a step of causing said client apparatus to receive, via the communication network, the advertisement information transmitted by said server apparatus in accordance with the type of the performance equipment being used in said particular client apparatus, and reproducing the advertisement information received from said server apparatus.

44. A method for supplying information from a server apparatus to a client apparatus via a communication network, said method comprising:
a step of selecting, on the basis of client information including musical information indicative of contents of musical performance training to be received via a particular client apparatus, advertisement information related to the contents of the musical performance training to be received; and
a step of performing control such that the selected advertisement information is transmitted to said particular client apparatus via the communication network.

45. A method for communicating information between a server apparatus and a client apparatus via a communication network, said method comprising:
a step of performing control such that client information including musical information indicative of contents of musical performance. training to be received via a particular client apparatus is transmitted to said server apparatus via the communication network; and
a step of receiving, via the communication network, advertisement information that is transmitted by said server apparatus in response to the musical information and is related to the contents of the musical performance training, and reproducing the advertisement information received from said server apparatus.

46. A method for communicating information between a server apparatus and a client apparatus via a communication network, said method comprising:
a step of causing said server apparatus to select, on the basis of client information including musical information indicative of contents of musical performance training to be received via a particular client apparatus, advertisement information related to the contents of the musical performance training;
a step of causing said server apparatus to perform control such that client information including musical information indicative of contents of musical performance training to be received via a particular client apparatus is transmitted to said server apparatus via the communication network; and
a step of causing said client apparatus to receive, via the communication network, advertisement information that is transmitted by said server apparatus in response to the musical information and is related to the contents of the musical performance training, and reproducing the advertisement information received from said server apparatus.

47. A method for supplying information from a server apparatus to a client apparatus via a communication network, said method comprising:
a step of providing a program for use in musical training which is composed of a plurality of musical performance training programs;
a step of selecting any one of the plurality of musical performance training programs stored in said memory, in response to a request made by a particular client apparatus via which a user receives musical training;
a step of performing a billing operation for billing said client apparatus for the selected musical performance training program; and
a step of performing control such that the musical performance training program selected via said step of selecting is transmitted to said particular client apparatus via the communication network.

48. A method for communicating information between a server apparatus and a client apparatus via a communication network, said method comprising:
a step of causing said client apparatus to transmit request information to said server apparatus via the communication network, said request information requesting any one of a plurality of musical performance training programs composing a program for use in musical training so that said server apparatus supplies said requested one of the musical performance training programs to said client apparatus via the communication network; and
a step of causing said client apparatus to receive, via the communication network, said requested one of the musical performance training programs that is supplied by said server apparatus in response to the request information.

49. A method for communicating information between a server apparatus and a client apparatus via a communication network, said method comprising:
a step of providing a program for use in musical training which is composed of a plurality of musical performance training programs;
a step of causing said server apparatus to select any one of the plurality of musical performance training programs, in response to a request made by a particular client apparatus via which a user receives musical training;
a step of causing said server apparatus to perform a billing operation for billing said client apparatus for the musical performance training program; selected by said server apparatus
a step of causing said server apparatus to perform control such that the selected musical performance training program is transmitted to said particular client apparatus via the communication network;
a step of causing said client apparatus to perform control such that request information requesting any one of the plurality of musical performance training programs composing the program for use in musical training is transmitted to said server apparatus via the communication network; and
a step of causing said client apparatus to receive, via the communication network, one of the musical performance training programs that is transmitted by said server apparatus in response to the request information.

50. A machine-readable storage medium containing a program to cause a processor to perform an information supply method for supplying information from a server apparatus to a client apparatus via a communication network, said information supply method comprising:
a step of selecting, on the basis of client information including musical information indicative of a type of performance equipment being used in a particular client apparatus, advertisement information related to the type of the performance equipment; and
a step of performing control such that the advertisement information selected via said step of selecting is transmitted to said particular client apparatus via the communication network.

51. A machine-readable storage medium containing a program to cause a processor to perform a method for communicating information between a server apparatus and a client apparatus via a communication network, said method comprising:
a step of performing control such that client information including musical information indicative of a type of performance equipment being used in a particular client apparatus is transmitted to said server apparatus via the communication network; and
a step of receiving, via the communication network, advertisement information that is transmitted by said server apparatus in response to the musical information and is related to the type of the performance equipment being used in said particular client apparatus, and reproducing the advertisement information received from said server apparatus.

52. A machine-readable storage medium containing a program to cause a processor to perform a method for communicating information between a server apparatus and a client apparatus via a communication network, said method comprising:
a step of causing said server apparatus to select, on the basis of client information including musical information indicative of a type of performance equipment being used in a particular client apparatus, advertisement information related to the type of the performance equipment;
a step of causing said server apparatus to perform control such that the advertisement information selected by said server apparatus is transmitted to said particular client apparatus via the communication network; and
a step of causing said client apparatus to receive, via the communication network, the advertisement information transmitted by said server apparatus in accordance with the type of the performance equipment being used in said particular client apparatus, and reproducing the advertisement information received from said server apparatus.

53. A machine-readable storage medium containing a program to cause a processor to perform a method for supplying information from a server apparatus to a client apparatus via a communication network, said method comprising:
a step of selecting, on the basis of client information including musical information indicative of contents of musical performance training to be received via a particular client apparatus, advertisement information related to the contents of the musical performance training to be received; and
a step of performing control such that the selected advertisement information is transmitted to said particular client apparatus via the communication network.

54. A machine-readable storage medium containing a program to cause a processor to perform a method for communicating information between a server apparatus and a client apparatus via a communication network, said method comprising:
a step of performing control such that client information including musical information indicative of contents of musical performance training to be received via a particular client apparatus is transmitted to said server apparatus via the communication network; and
a step of receiving, via the communication network, advertisement information that is transmitted by said server apparatus in response to the musical information and is related to the contents of the musical performance training, and reproducing the advertisement information received from said server apparatus.

55. A machine-readable storage medium containing a program to cause a processor to perform a method for communicating information between a server apparatus and a client apparatus via a communication network, said method comprising:
a step of causing said server apparatus to select, on the basis of client information including musical information indicative of contents of musical performance training to be received via a particular client apparatus, advertisement information related to the contents of the musical performance training;
a step of causing said server apparatus to perform control such that client information including musical information indicative of contents of musical performance training to be received via a particular client apparatus is transmitted to said server apparatus via the communication network; and
a step of causing said client apparatus to receive, via the communication network, advertisement information that is transmitted by said server apparatus in response to the musical information and is related to the contents of the musical performance training, and reproducing the advertisement information received from said server apparatus.

56. A machine-readable storage medium containing a program to cause a processor to perform a method for supplying information from a server apparatus to a client apparatus via a communication network, said method comprising:
a step of providing a program for use in musical training which is composed of a plurality of musical performance training programs;
a step of selecting any one of the plurality of musical performance training programs stored in said memory, in response to a request made by a particular client apparatus via which a user receives musical training;
a step of performing a billing operation for billing said client apparatus for the selected musical performance training program; and
a step of performing control such that the musical performance training program selected via said step of selecting is transmitted to said particular client apparatus via the communication network.

57. A machine-readable storage medium containing a program to cause a processor to perform a method for communicating information between a server apparatus and a client apparatus via a communication network, said method comprising:
a step of causing said client apparatus to transmit request information to said server apparatus via the communication network, said request information requesting any one of a plurality of musical performance training programs composing a program for use in musical training so that said server apparatus supplies said requested one of the musical performance training programs to said client apparatus via the communication network; and
a step of causing said client apparatus to receive, via the communication network, said requested one of the musical performance training programs that is supplied by said server apparatus in response to the request information.

58. A machine-readable storage medium containing a program to cause a processor to perform a method for communicating information between a server apparatus and a client apparatus via a communication network, said method comprising:
a step of providing a program for use in musical training which is composed of a plurality of musical performance training programs;
a step of causing said server apparatus to select any one of the plurality of musical performance training programs, in response to a request made by a particular client apparatus via which a user receives musical training;
a step of causing said server apparatus to perform a billing operation for billing said client apparatus for the musical performance training program selected by said server apparatus;
a step of causing said server apparatus to perform control such that the selected musical performance training program is transmitted to said particular client apparatus via the communication network;
a step of causing said client apparatus to perform control such that request information requesting any one of the plurality of musical performance training programs composing the program for use in musical training is transmitted to said server apparatus via the communication network; and
a step of causing said client apparatus to receive, via the communication network, one of the musical performance training programs that is transmitted by said server apparatus in response to the request information.
